(19) United States
(12) Patent Application Publication
(10) Pub. No.: US 2024/0411282 A1
(43) Pub. Date: Dec. 12, 2024

(54) MANUFACTURING INTEGRATION SYSTEM

(71) Applicant: Rivian IP Holdings, LLC, Irvine, CA (US)

(72) Inventors: Tanvir MUDHAR, Hayward, CA (US); Ghassan KHREIS, San Francisco, CA (US); Aldo ANSEL, Irvine, CA (US)

(21) Appl. No.: 18/737,508

(22) Filed: Jun. 7, 2024

Related U.S. Application Data
(60) Provisional application No. 63/507,409, filed on Jun. 9, 2023.

(51) Int. Cl. G05B 19/05

(52) U.S. Cl. CPC G05B 19/05; G05B 2219/13172

(57) ABSTRACT

A system includes a plurality of manufacturing tools configured to perform a physical action contributing to manufacture of a product. The system further includes one or more programmable controllers coupled to the plurality of manufacturing tools and one or more lineside units coupled to the one or more programmable controllers. The one or more lineside units each configured to cooperate with the one or more programmable controllers to discover tool data describing services performed by one or more of the plurality of manufacturing tools, including command sets. The one or more lineside units receive a process definition from a remote manufacturing control system and translate the process definition into commands to the plurality of manufacturing tools according to the tool data. Results of implementing the commands is asynchronously reported to the manufacturing control system. The process definition may be retrieved directly from a manufacturing database.

### RELATED APPLICATION

This application claims the benefit of U.S. Application Ser. No. 63/507,409 filed Jun. 9, 2023, and entitled MANUFACTURING LINESIDE UNIT FOR FACILITATING INTEGRATION WITH A MANUFACTURING EXECUTION SYSTEM, which is hereby incorporated herein by reference in its entirety.

### INTRODUCTION

The present disclosure relates to manufacturing and, more particularly, to systems for integrating manufacturing processes and information.

### SUMMARY

The present disclosure describes various techniques for controlling the manufacture of a product. According to an embodiment a system includes one or more processing devices and one or more memory devices operably coupled to the one or more processing devices. The one or more memory devices store executable code that, when executed by the one or more processing devices, causes the one or more processing devices to connect to one or more programmable controllers that are coupled to one or more manufacturing tools, which are configured to perform a physical action contributing to manufacture of a product. The executable code further causes the one or more processors to extract, via the one or more programmable controllers, tool data associated with the one or more manufacturing tools, wherein the tool data describes services performed by the one or more manufacturing tools. Upon receiving a process definition from a remote manufacturing control system, the process definition is translated into commands to the one or more manufacturing tools according to the tool data. The executable code further causes the one or more processors to facilitate execution of the commands such that the one or more manufacturing tools perform one or more physical actions corresponding to the process definition.

The tool data may include one or more command sets. The executable code, when executed by the one or more processing devices, further causes the one or more processing devices to translate, using the one or more command sets, the process definition into the commands to the one or more manufacturing tools.

In some embodiments, the executable code, when executed by the one or more processing devices, further causes the one or more processing devices to manage sequential submission of the commands to the one or more manufacturing tools.

In some embodiments, the executable code, when executed by the one or more processing devices, further causes the one or more processing devices to asynchronously report results of the commands to the remote manufacturing control system. The results may be translated to obtain translated results and the translated results are then transmitted to the remote manufacturing control system.

In some embodiments, the executable code, when executed by the one or more processing devices, further causes the one or more processing devices to request the process definition from a database.

In some embodiments, the executable code, when executed by the one or more processing devices, further causes the one or more processing devices to cooperate with the one or more programmable controllers to discover the tool data in response to one or more messages from the one or more programmable controllers.

According to another embodiment, a system includes a plurality of manufacturing tools configured to perform a physical action contributing to manufacture of a product. The system further includes one or more programmable controllers coupled to the plurality of manufacturing tools and one or more lineside units coupled to the one or more programmable controllers. The one or more lineside units each configured to cooperate with the one or more programmable controllers to discover tool data describing services performed by one or more of the plurality of manufacturing tools. The one or more lineside units receive a process definition from a remote manufacturing control system and translate the process definition into commands to the plurality of manufacturing tools according to the tool data.

In some embodiments, the tool data includes one or more command sets. The one or more lineside units are each configured to translate the process definition into the commands to the plurality of manufacturing tools using the one or more command sets. Each of the one or more lineside units may be configured to manage submission of the commands to the plurality of manufacturing tools. The one or more lineside units may be configured to read status information from a memory of each programmable controller of the one or more programmable controllers. The lineside units may control a rate at which the commands are submitted to the one or more programmable controllers according to the status information.

In some embodiments, the one or more lineside units may be configured to asynchronously report results of the commands to the remote manufacturing control system. The one or more lineside units may be configured to translate the results to obtain translated results and transmit the translated results to the remote manufacturing control system. Each of the one or more lineside units may configured to request the process definition from a database.

In some embodiments, each lineside unit of the one or more lineside units is configured to cooperate with the one or more programmable controllers to discover the tool data in response to one or more messages from the one or more programmable controllers.

According to yet another embodiment, a method for manufacturing a product includes connecting a programmable controller to a lineside unit, the programmable controller coupled to one or more automated tools configured to perform a physical action contributing to manufacture of a product. The method further includes receiving, by the lineside unit, tool data from the programmable controller, the tool data including a command set for the one or more automated tools. The method further includes receiving, by the lineside unit, a process definition from a remote manufacturing control system and translating, by the lineside unit, the process definition into a plurality of commands using the tool data. The lineside unit sequentially invokes execution of the plurality of commands by the programmable controller and the one or more automated tools to implement the process definition.

In some embodiments, the method includes asynchronously reporting, by the lineside unit, results of the plurality of commands to the remote manufacturing control system. The method may include translating, by the lineside unit, the results to obtain translated results and transmitting, by the lineside unit, the translated results to the remote manufacturing control system.

In some embodiments, the method further includes detecting, by the lineside unit, modification of a remote database and, in response to detecting modification of the remote database, retrieving, by the lineside unit, the process definition from the remote database. The remote database may be a factory talk production center (FTPC) database.

In some embodiments, the lineside unit is within eight meters of the one or more automated tools.

### BRIEF DESCRIPTION OF THE DRAWINGS

FIG. 1 illustrates an example manufacturing environment, in accordance with certain embodiments.

FIG. 2 illustrates an example manufacturing environment including a cloud computing platform, in accordance with certain embodiments.

FIG. 3 illustrates a lineside unit for facilitating integration between a controller for a manufacturing device and a manufacturing execution system, in accordance with certain embodiments.

FIG. 4 illustrates the exchange of feature requests between the controller for a manufacturing device and an interface of a lineside unit, in accordance with certain embodiments.

FIG. 5 illustrates interconnected lineside units, in accordance with certain embodiments.

FIG. 6 illustrates a schematic block diagram of components for translating data sent to and received from a controller for a manufacturing device, in accordance with certain embodiments.

FIG. 7 illustrates various stages of a transform, in accordance with certain embodiments.

FIG. 8 is a process flow a diagram illustrating the exchange of data between a controller for a manufacturing device and services, such as a manufacturing execution system, in accordance with certain embodiments.

FIG. 9 is schematic block diagram of a runtime model in accordance with certain embodiments.

FIG. 10 is a schematic block diagram of an event processing architecture, in accordance with certain embodiments.

FIG. 11 is a schematic block diagram illustrating the use of feedback in the event processing architecture, in accordance with certain embodiments.

### DETAILED DESCRIPTION

Various vendors provide manufacturing execution system (MES) that are used to control, track, and document multi-stage manufacturing processes. For example, the Rockwell MES is commonly used. The manufacturing process typically includes the use of automated tools such as robotic arms, torque tools, cutting tools, cameras, measurement sensors, and the like. Each automated tool either includes or is controlled by a programmable control device, often implemented as a programmable logic controller (PLC). Each device has different instruction sets, capabilities, and formats for sending and receiving data. Accordingly, in prior approaches, vendors of the automated tools or some other third party provides a dedicated middleware application for enabling the automated tools to interface with the MES. Even with such middleware, the process of integrating a new automated tool requires a great detail of human involvement, including the designers of the manufacturing process, software engineers, and controls engineers.

The present disclosure describes various ways to facilitate integration with a manufacturing execution system. A programmable logic controller (PLC), or other control device, is configured with data describing services offered by the PLC, which may include command sets for accessing the services. A lineside unit located proximate a tool controlled by the PLC connects to the PLC and cooperates with the PLC to perform discovery of the services and command sets. The lineside unit may then translate subsequently received process definitions into tasks using the services and command sets. The tasks may then be processed by the lineside unit by submitting commands to the PLC for execution. Results of performing the tasks are asynchronously reported to the manufacturing execution system. The process definition itself may be directly retrieved from a manufacturing database, further reducing loading of the manufacturing execution system.

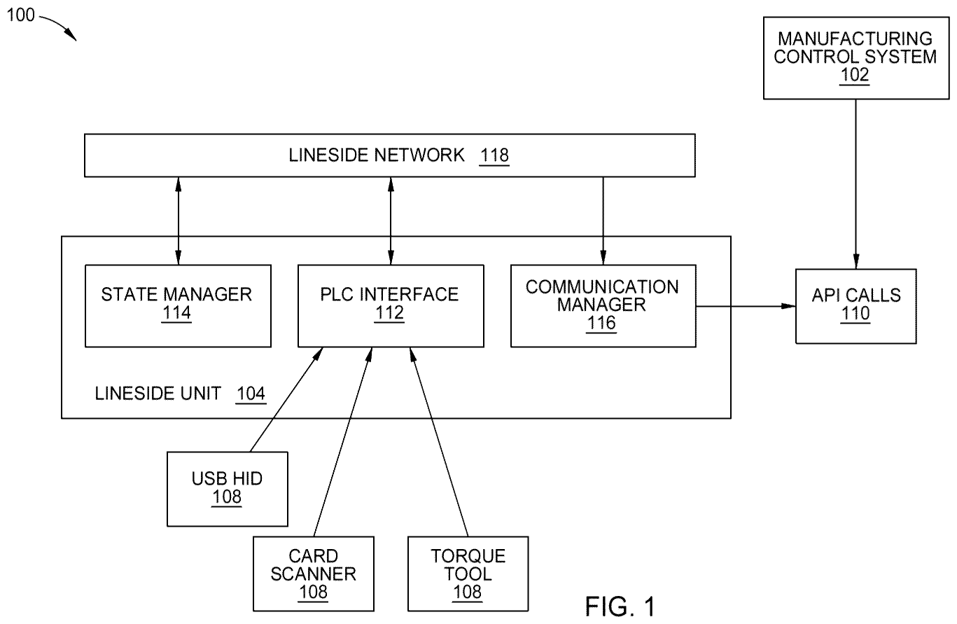

Referring to FIG. 1, a manufacturing environment 100 may be used to manufacture a complex product such as an automobile, agricultural or industrial machinery, electronic device, or other product. The manufacturing environment 100 includes a manufacturing control system 102. The manufacturing control system 102 provides centralized control and monitoring of a plurality of manufacturing tools and may further provide human-accessible interfaces for evaluating and visualizing a state of a manufacturing facility and reviewing records for the manufacture of a particular item. The manufacturing control system 102 may be implemented as a manufacturing execution system (MES) offered by a third party vendor, such as an MES provided by ROCKWELL AUTOMATION, SIEMENS, SAP, or the like.

The manufacturing environment 100 includes one or more lineside units 104. Each lineside unit 104 may be embodied as programmable computing device including one or more processing devices, one or more transient memory devices, and one or more persistent storage devices coupled to one another along with other components to facilitate operation of the computing device. The lineside units 104 are coupled to various tools 108 that are managed by the lineside units 104. The lineside units 104 may be connected to one or more programmable logic controllers (PLC) 106 that are each coupled to one or more tools 108 that are controlled by the PLC. A PLC 106 is one example of a programmable controller for a tool 108 and other programmable controllers may also perform the functions ascribed herein to the PLC 106.

The tools 108 may include, for example, a robotic arm, a card scanner, a torque tool, and human interface device (HID) (touch screen, keyboard, pointing device, etc.), or any other tool that can perform a physical action contributing to the manufacture of a product, verify dimensions or other property of a product, transport a product or a component of a product, or perform any other action constituting part of the production of a product. Note that the tools 108 illustrated in FIG. 1 are exemplary and that any other manufacturing tools described above may be used in conjunction with the embodiments described herein.

The lineside unit 104 may be local to the tools coupled thereto, such as located along a production line or otherwise within a threshold distance (e.g., within 1, 2, 4, or 8 meters) of the tools coupled thereto. The lineside unit 104 may be coupled to the tools directly (e.g., by a universal serial bus (USB) or other type of cable connected to a port of the lineside unit 104) or by a network (e.g., a local area network (LAN) implemented over wires, wireless signals, or fiber optic cables) with communication between the lineside unit 104 and the tools established according to a networking protocol (e.g., internet protocol (IP)), transmission control protocol (TCP), user datagram protocol (UDP), or the like).

The manufacturing control system 102 may be remote from the lineside unit 104 and be connected thereto by a network, such as a local area network (LAN) or wide area network (WAN) implemented over wires, wireless signals, or fiber optic cables. The manufacturing control system 102 may be coupled to a plurality of lineside units 104 on one or more production lines for one or more products. The manufacturing control system 102 may communicate with one another using application programming interface (API) calls, such as REST API calls transmitted over the network according to a networking protocol. Data exchanged with the manufacturing control system 102 may be in the form of objects, such as JAVASCRIPT object notation (JSON) objects.

The system described herein advantageously facilitates the integration of PLCs 106 and tools 108 from multiple third party vendors and a manufacturing control system 102 from yet another third party vendor. Each of the PLCs 106 and tools 108 and the manufacturing control system 102 may have proprietary interfaces, such as data representations, instructions (e.g., binary code words), communication protocols, and the like. The lineside units 104 may be independent of all the third party vendors and facilitate the integration therebetween as described hereinbelow. The system described herein will also be useful for integrating between PLCs 106, tools 108, and manufacturing control system 102 that are not from different vendors.

Each lineside unit 104 may include a device interface 112 configured to interface with the tools coupled to the lineside unit 104. As discussed in greater detail below, the device interface 112 operates to discover the tools, discover services and command sets for the tools, and manage communication of instructions to the tools.

Each lineside unit 104 may include a state manager 114. As discussed in greater detail below, the state manager 114 invokes execution of a sequence of individual commands constituting a multi-step manufacturing processes received from the manufacturing control system 102, including passing each individual command constituting the multi-step manufacturing process to the device interface 112 to implement with respect to a tool referenced by the command.

Each lineside unit 104 may include a communication manager 116. As discussed in greater detail below, the communication manager 116 manages receiving a definition of a manufacturing process, translating the definition into instructions to the device interface 112, and transmitting the status of execution of the manufacturing process to the manufacturing control system 102.

A plurality of lineside unit 104 may be coupled to a lineside network 118. The lineside network 118 may be embodied as a message sharing protocol implemented on top of a wired, wireless, or fiber optic network implemented using a networking protocol. For example, the lineside network 118 may be embodied as a streaming protocol facilitating the streaming of events by components connected to the lineside network 118 that may be consumed by other components connected to the lineside network 118. For example, the lineside network 118 may be implemented using KAFKA, NATS JETSTREAM, or other stream management protocol.

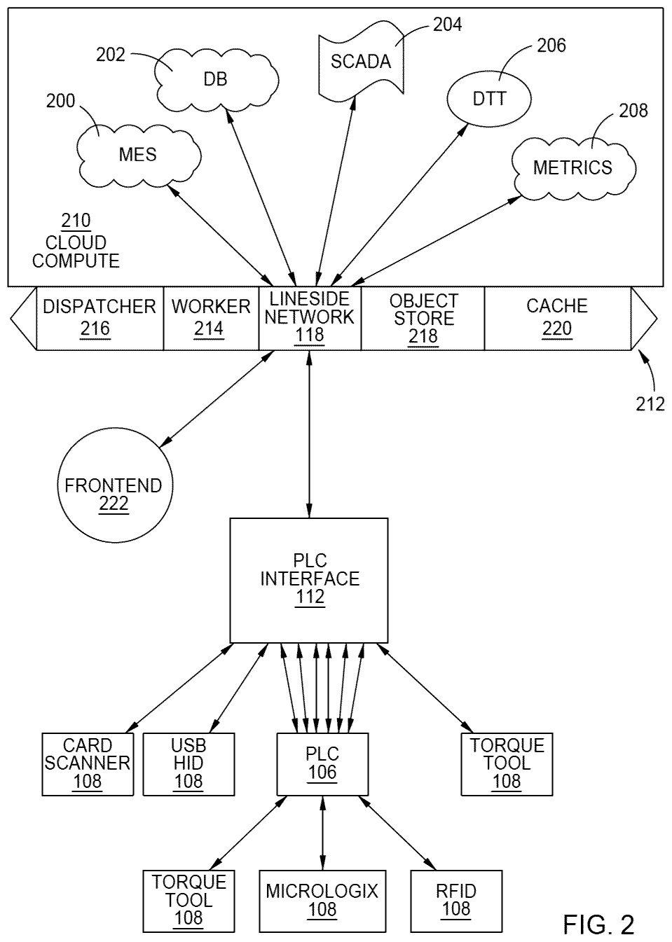

Referring to FIG. 2, the manufacturing control system 102 is just one example of a consumer of messages from lineside units 104 and a source of instructions to the lineside units 104. For example, the manufacturing control system 102 may be implemented as an MES 200. Other consumers of information from the lineside units 104 or sources of instructions may include a database 202 (SQL, DB2, ORACLE, etc.), supervisory control and data acquisition (SCADA) software 204, DTT 206, or metrics 208 (e.g., key performance indicators (KPI) or other metrics).

Some or all of the consumers of information from the lineside units 104 or sources of instructions to the lineside units 104 may be hosted by a cloud computing platform 210. The lineside network 118 may be implemented by one or more edge computing components 212 that are implemented by the cloud computing platform 210 or by a component through which lineside units 104 access the cloud computing platform 210 or are accessed from within the cloud computing platform 210. The one or more edge computing components 212 may implement other components for facilitating communication between the lineside units 104 and components executing within the cloud computing platform 210. For example, the one or more edge computing components 212 may include workers 214 (e.g., containers), a dispatcher 216 for assigning tasks to workers 214, an object store storing objects 218 transmitted to or from the lineside units 104, and a cache 220 for storing repeatedly used data.

A front end 222 may be coupled to the lineside network 118 and receive messages streamed over the lineside network 118. The front end 222 may be hosted by the one or more edge computing components 212. The front end 222 may be embodied as software programmed to extract and format data from the messages for viewing by a human operator to provide a visualization of manufacturing processes implemented using the lineside units 104.

As further shown in FIG. 2, the PLC 106 may control a plurality of tools 108 coupled thereto, such as the illustrated torque tool, MICROLOGIX controller, radio frequency identifier (RFID) reader, or any of the other tools described herein.

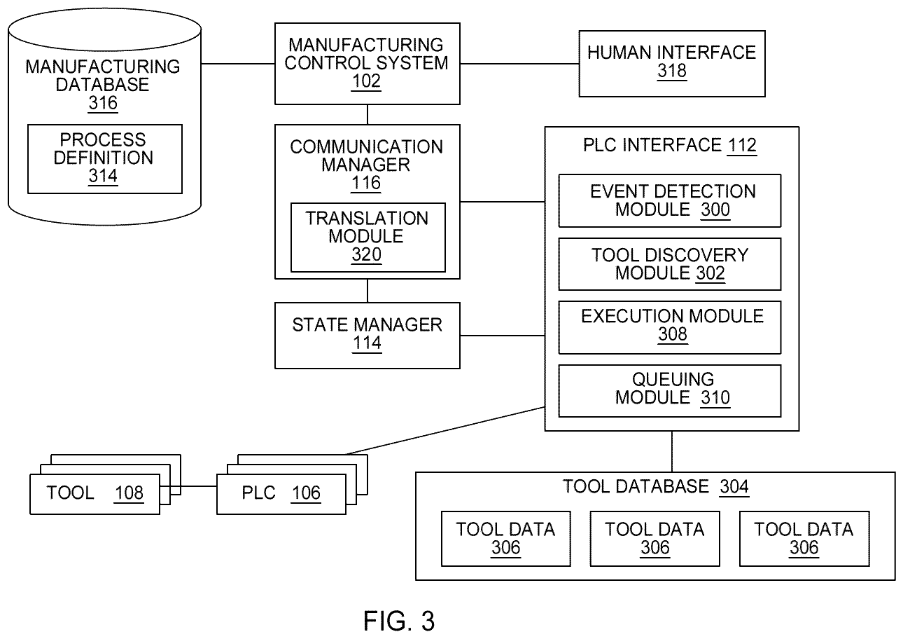

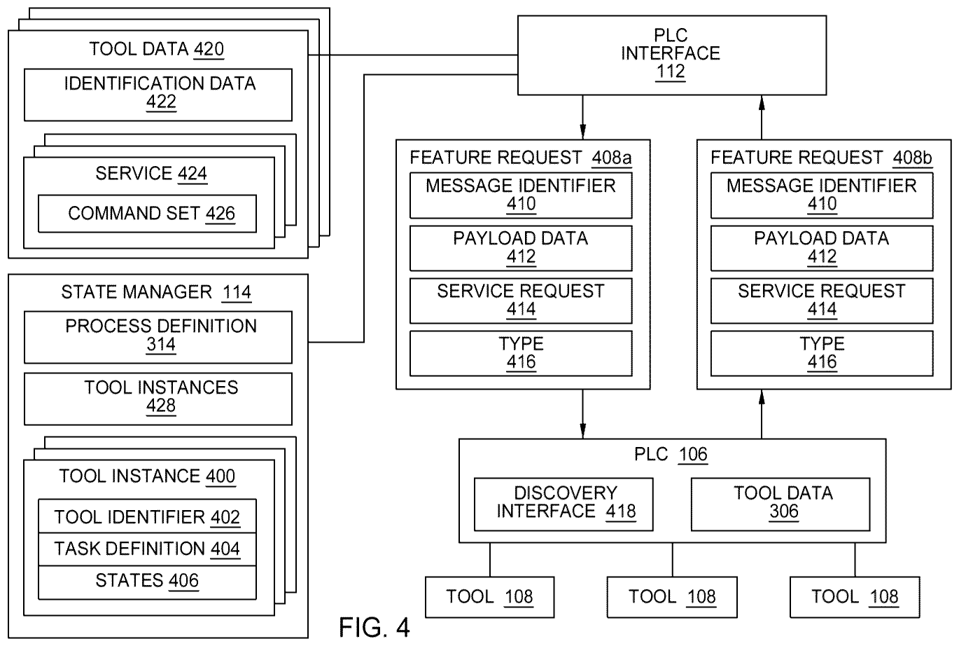

FIG. 3 illustrates the operation of the device interface 112, state manager 114, and communication manager 116 of a lineside unit 104. The device interface 112 may perform discovery of tools 108 coupled thereto. For example, the device interface 112 may include an event detection module 300. Events detected by the event detection module 300 may include the connection of a tool (a) directly to the lineside unit 104 hosting the device interface 112 or (b) to a PLC 106 coupled to the lineside unit 104, (c) an initial connection of the PLC 106 to the lineside unit 104. For example, a PLC 106 may be programmed to output an event to the lineside unit 104 in response to configuration of the PLC 106 to control an item of equipment (see discussion of feature requests with respect to FIG. 4) and/or upon an initial connection of the PLC 106 to the lineside unit 104. The PLC 106 may output the event following performance of an initial handshaking protocol with the lineside unit 104.

In response to an event indicating coupling of a tool 108 or initial connection to the PLC 106, the device interface 112 may invoke a tool discovery module 302. The tool discovery module 302 populates a tool database 304 local to the lineside unit 104 including tool data 306 for each tool 108 detected by the tool discovery module 302. The tool data 306 includes some or all of a unique identifier, attributes, services, and command set for a particular tool. The tool discovery module 302 may extract the tool data 306 via the PLC 106, either by receiving a message (e.g., feature request as discussed below) from the PLC 106 or tool 108 or by reading directly from the memory of the PLC 106 or tool 108 as also discussed below.

The device interface 112 includes an execution module 308. The execution module 308 translates a command in the command set of a tool 108 into a series of one or more instructions, such as binary codes, intelligible by tool 108. The device interface 112 may include a queueing module 310 that submits individual instructions to each tool in an order specified in a process definition 314 and at a rate that is appropriate to the item of equipment.

Commands for execution by the tools 108 are derived from the process definition 314, which may be stored in a manufacturing database 316. The process definition 314 specifies a sequence of manufacturing procedures to be performed to implement all or part of the process of a manufacturing a product. For example, the manufacturing database 316 may be implemented as an entry in a Factory Talk Production Center (FTPC) database and the process definition 314 may be embodied as work construction according to FTPC. The manufacturing databases 316 may store each process definition 314 as an entry in a structured query language (SQL) entry in the manufacturing database 316. Each process definition 314 may be generated in response to inputs received through a human machine interface (HMI) 318. The human machine interface 318 may be implemented as an application or browser executing on a laptop, desktop, tablet, or other computing device.

Addition of the process definition 314 to the manufacturing database 316 may be detected as an event by the event detection module 300 or some other component of the lineside unit 104. In response to the addition of the process definition 314, the communication manager 116 may retrieve the process definition 314 from the manufacturing database 316 using a hypertext transport protocol (HTTP) request, query (e.g., SQL query), or other type of request. In some embodiments, the process definition 314 may be translated by a translation module 320 of the communication manager 116. For example, the process definition 314 may use commands, syntax, data representation, format, or other attributes that are particular to a vendor of the manufacturing control system 102. Accordingly, the process definition 314 may be translated into a form used by the device interface 112, such as the form used to represent commands in the command sets of the tools 108. The translation module 320 may implement any approach known in the art for translating between instruction sets, such as gRPC (gRPC Remote Procedure Call) or analogous approach.

The communication manager 116 passes the process definition 314, e.g., the translated version of the process definition 314, to the state manager 114. The state manager 114 will then manage the execution of the process definition 314, including generating a series of commands passed to the device interface 112 for execution. The device interface 112 then facilitates execution of the commands by the PLC 106 and/or tools 108, which may include translating each command into one or more instructions, e.g., binary codes, and transmitting the instructions to a tool 108 referenced by the command directly or by way of the PLC 106. The tool data 306 may define the translation between a command and the one more instructions. As discussed below, the instructions may be transmitted to the tool 108 directly or by way of the PLC 106 using feature requests.

Referring to FIG. 4, state manager 114 may execute the process definition 314 by creating a plurality of task instances 400 that collectively manage the performance of tasks included in the process definition 314 in a sequence specified in the process definition 314. The state manager 114 therefore relieves the manufacturing control system 102 from the burden of performing this task. Each task instance 400 may be an instance of a task manager executable that manages the execution of a task from the process definition 314 assigned to the state manager 114. Each task instance 400 manages execution of the task assigned thereto by a particular tool 108. The task instance 400 may therefore include such information as an identifier 402 of the tool 108 and a task definition 404. The task definition may include commands as well as arguments to commands such as part numbers, pallet numbers, a workstation identifier, attributes (color, options, one of a plurality of selectable alternatives) of parts or material to be used in the task, tracking functions (assignment of part numbers, removal of a prior part number), quality assurance measurements and tolerances, or any other data describing the inputs, actions performed, or desired outputs of the task.

The task instance 400 may include one or more states 406. The one or more states 406 indicate a state of completion of each command of a task and the one or more states 406 are updated as commands are acknowledged to be received, in process, and completed by the device interface 112. The task definition 404 may define state triggers including a trigger condition and an event generated in response to the trigger condition being satisfied. For example, the trigger condition may include completion of execution of a particular command.

An event may be a message that is transmitted to the manufacturing control system 102. Events generated in response to state triggers may also be streamed over the lineside network 118. Events generated in response to state triggers may be transmitted to the manufacturing control system 102 by way of the communication manager 116. The events may be converted to objects, such as JSON objects, by the translation module 320 and transmitted to the manufacturing control system 102 using API calls 110. The translation module 320 may further translate the events into a form that the manufacturing control system 102 is programmed to receive. The communication manager 116 is independent from the PLC 106 and can therefore send the events to the manufacturing control system 102 asynchronously from operation of the PLC 106 and further relieves the PLC 106 of the computational burden of managing connections to and communication with the manufacturing control system 102.

FIG. 4 further illustrates the communication between the device interface 112 and a PLC 106. The PLC 106 may exchange information with the device interface 112 by way of messages known herein as feature requests, including feature requests 408a transmitted from the device interface 112 to the PLC 106 (“outbound feature requests 408a”) and feature requests transmitted from the PLC 106 to the device interface 112 (“inbound feature requests 408b”).

Each feature request 408a, 408b may include a message identifier 410 used to relate feature requests 408a, 408b to one another. For example, the message identifier 410 may be a universally unique identifier (UUID) that is unique to all messages exchanged by a given lineside unit 104 or across all lineside units 104. For example, an outbound feature request 408a may invoke the PLC 106 to send a corresponding inbound feature request 408b in response, e.g., acknowledgement of completion of an action defined in the outbound feature request 408a. The PLC 106 may assign the same message identifier 410 to the inbound feature request 408b as was assigned to the corresponding outbound feature request 408a. The device interface 112 can therefore verify completion of commands asynchronously without waiting for a response before generating another outbound feature request for a different tool 108 or different PLC 106.

Each feature request 408a, 408b may include payload data 412, i.e., data to be communicated by the feature request 408a, 408b. The payload data 412 may include a listing of one or more items of status information, a list of one or more attributes, one or more time stamps, or other data describing a completed action or an action to be completed.

Each feature request 408a, 408b may optionally include a service request 414. A service request 414 specifies an action to be performed by the recipient of the feature request 408a, 408b. The service request 414 may include instruction words or codes invoking an action that correspond to a command received by the device interface 112. The service request 414 may further include arguments governing performance of an action, identifiers of an article to be acted upon, or other data defining an action to be performed.

In some embodiments, each feature request 408a, 408b is of a particular type 416. That is to say that a feature request 408a, 408b may be one of a finite set of feature requests with the payload data 412 and service request 414 being arguments for each type 416. The type 416 itself may specify how the feature request 408a, 408b is processed by the recipient thereof.

In one example use of feature requests 408a, 408b, the PLC 106 detects that a new tool 108 has been connected to the PLC 106 and that the PLC 106 has been configured with tool data 306 for the new tool 108. The tool data 306 may include identification information of the new tool 108, which may include a unique identifier and/or location information (e.g., an identifier of a station where the new tool 108 is located). The tool data 306 may further list services offered by the new tool 108, which may include a listing of attributes of each service and a command set for accessing each service. The PLC 106 may include a discovery interface 418 that detects the change to the configuration of the PLC 106 and generate an inbound feature request 408b including a service request 414 that instructs the tool discovery module 302 to store tool data 420 describing the new tool 108. The tool data 420 may include, for example, identification data 422 including an identifier of the new tool 108 and possibly other identifying data such as location data. The tool data 420 may include service data 424 describing services provided by the new tool 108. The service data 424 for a service may include attributes of the service and may further include a command set 426 listing commands that may be used to invoke functions of the service.

In some embodiments, the state manager 114 may further add a tool instance 428 in response to the feature request 408b referencing the new tool 108. The tool instance 428 may include state variables representing the tool instance 428 and functions enabling the state manager 114 to create tasks instances 400 for tasks to be performed by the new tool 108. Task instances 400 referencing the new tool 108 may be created in response to subsequently received process definitions 314 referencing the identification data 422 of the new tool 108. For example, references to the identification data 422 of the new tool 108 may be added to the manufacturing database 316 by a human operator or in response to an event transmitted to the manufacturing control system 102 by the lineside unit 104 in response to detecting the new tool 108. Process definitions 314 referencing the new tool 108 may then be generated as described above.

In a second example use of feature requests 408a, the state manager 114 transmits a command to the device interface 112, the command referencing identification data 422. The device interface 112 uses the tool data 420 corresponding to the identification data 422 to obtain information enabling execution of the command, such as instructions or codes and corresponding arguments to pass to the PLC 106 having the tool 108 identified by the identification data 422 coupled thereto. The instructions or codes and corresponding arguments may then be passed to the PLC 106 as an outbound feature request 408a.

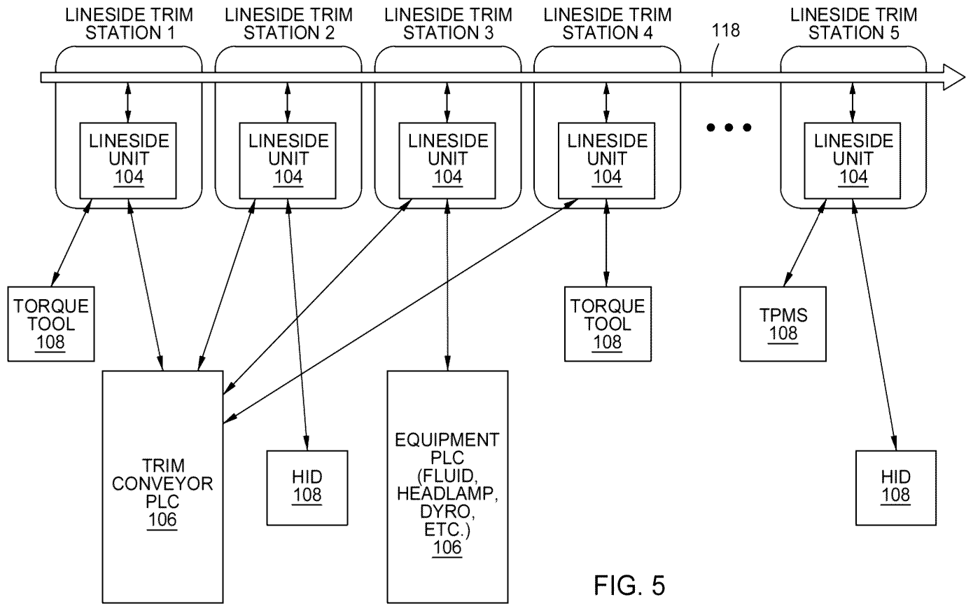

Referring to FIG. 5, in some embodiments, data is replicated across lineside units 104 connected to one another by the lineside network 118. Each lineside unit 104 is initially connected to one or more PLCs 106 and one or more tools 108, such as the illustrated torque tools, tire pressure monitoring system (TPMS), one or more human interface devices (HID), a PLC 106 managing a trim conveyor, a PLC 106 managing tools such as a fluid fill device, headlamp, dynamometer, or the like.

For example, tool instances 428 and tool data 420 for the tools 108 coupled to a first lineside unit 104 may be replicated on a second lineside unit 104. For example, a first lineside unit 104 may create events transmitted on the lineside network 118 in response to the addition of a new tool 108. Such events may include the tool instance 428 and tool data 420 or invoke the second lineside unit 104 that receives the events to request the tool instance 428 and tool data 420 from the first lineside unit 104. In some embodiments, copies of tasks instances 400 are also shared between lineside units 104 and the copies of the task instances maintained consistent as the states 406 of the original task instance 400 are changed, such as by sharing events over the lineside network 118. In this manner, if a first lineside unit 104 fails, a second lineside unit 104 may continue to perform the functions thereof. For example, the first lineside unit 104, second lineside unit 104, PLCs 106 managed by the first lineside unit 104, and PLCs 106 managed by the second lineside unit 104 may be coupled to a common network. The second lineside unit 104 may therefore continue to manage the PLCs 106 formerly managed by the first lineside unit 104 in response to failure thereof using the copies of the tasks instances 400 received by the second lineside unit 104 in order to complete the tasks represented by the copies of the task instances 400.

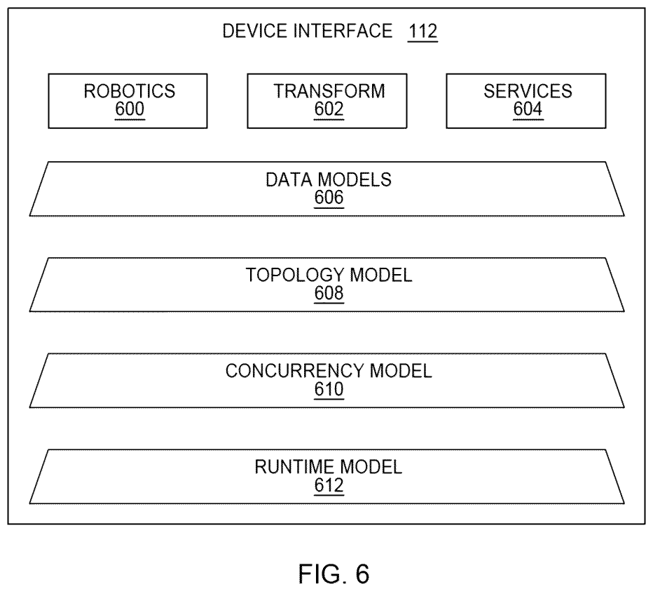

FIG. 6 illustrates components of the device interface 112 for performing translation between the representation of data that is at least one of (a) sent to a PLC 106 as an instruction, e.g., binary code, (b) received from a PLC 106 as binary code response, (c) raw binary data read directly from memory of the PLC 106, and (d) raw binary data written directly to the memory of the PLC 106. As for the embodiments described herein, a PLC 106 is described with the understanding that any programmable controller for a tool 108 may be used in a like manner.

The device interface 112 interfaces with robotics 600 embodied as a PLC 106, tool 108, or other device. The device interface 112 implements an interface of the PLC 106 for sending and receiving binary data from the robotics 600. The device interface 112 may further include executable code for reading data directly from the memory of the PLC 106. For example, the device interface 112 may include executable code invoking reading of data from the memory of robotics 600 one or both of (a) according to a predefined schedule, e.g., repetition rate and (b) in response to a triggering event. The triggering event may include detecting an unsafe condition in binary data included in messages transmitted by the PLC 106 or in response to commands generated in response to implementation of a process definition 314, or other type of triggering event.

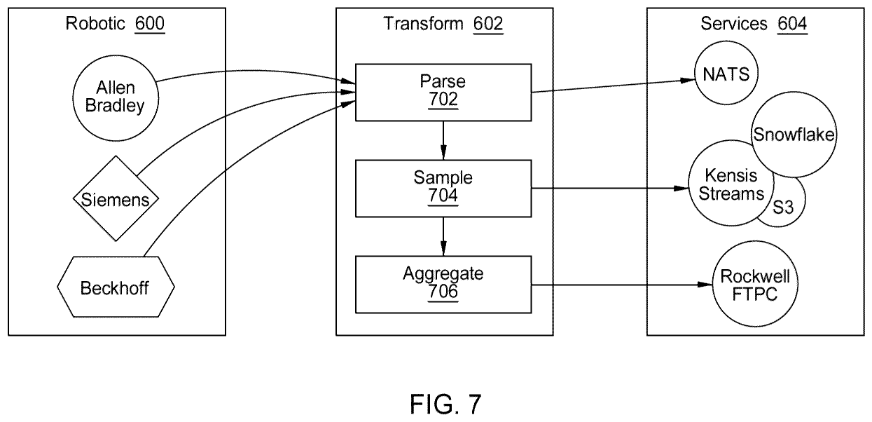

The device interface 112 includes a transform 602. The transform 602 includes executable data that transforms binary data received from the PLC 106 into a more abstract representation that is agnostic to the vendor of a given PLC 106 and tool 108. The transform 602 may likewise transform data in the abstract representation into binary data that is transmitted to the PLC 106 as an instruction or written directly to the memory of the PLC 106. The operation of the transform 602 is described in greater detail below with respect to FIG. 7.

The device interface 112 includes services 604. The services 604 include executable code implementing a source of commands or a consumer of information for tools 108 managed by the device interface 112. The services 604 may therefore include a source of the process definition 314 or a database or other interface for monitoring implementation of the process definition. The services 604 may execute locally to the device interface 112 or may execute on a remote computing device.

The device interface 112 may include data models 606. The data model 606 for a PLC 106 may include an object representing a current state of the PLC and that is updated in response to binary instructions sent to the PLC 106, data written to the memory from the PLC 106, binary messages received from the PLC 106, and data read from the memory of the PLC. The data model 606 may be used by the services 604 for the PLC 106 to generate instructions to transmit to the PLC 106 and to generate responses to other processes using the services 604.

The device interface 112 may include a topology model 608. The topology model 608 describes interrelationships between tools 108. For example, one tool 108 controlled by the PLC 106 may be a robotic arm. Another tool 108 may be the end effector of the robotic arm, such as a torque tool. Accordingly, the topology model 608 will include a data object including identifiers for the PLC 106, robotic arm, and torque tool and the relationship therebetween. The topology model 608 may identify tools 108 that are at a common station and relative locations thereof. The topology model 608 may identify stations along a production line and the location of each station on the production line.

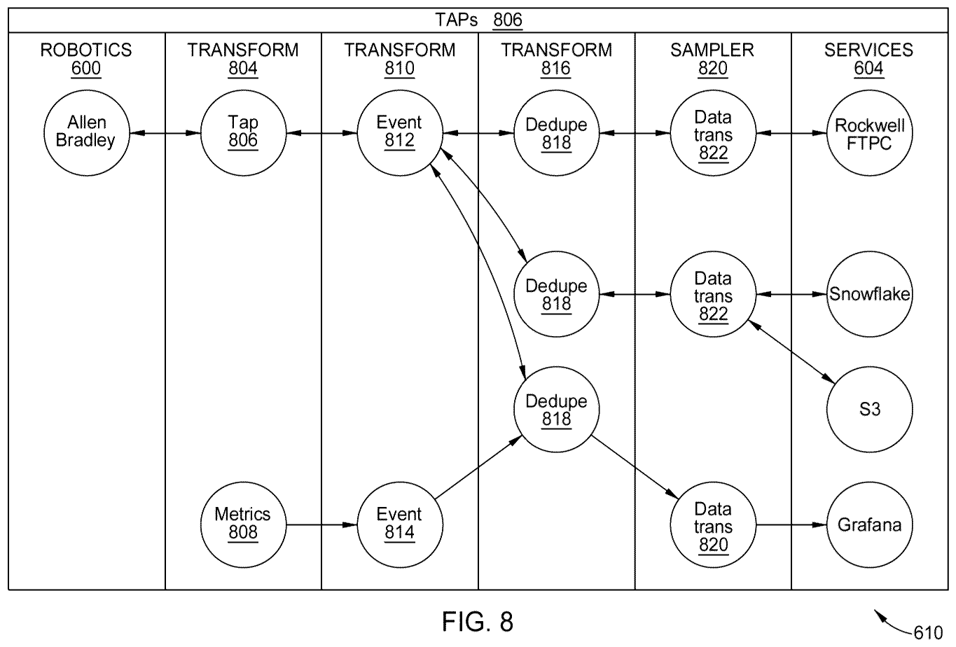

The device interface 112 may include a concurrency model 610. The device interface 112 will interface with multiple tools 108 simultaneously, either directly or by way of one or more PLCs 106. The concurrency model 610 may therefore manage execution of multiple threads of execution in order to accelerate performance of the device interface 112. For example, each tool 108 may have a corresponding thread managed by the concurrency model 610. The concurrency model 610 may further include logic for maintaining data consistency and coordinating between threads of related tools 108, e.g., a robotic arm and a tool that is the end effector of the robotic arm. A more detailed explanation of the concurrency model 610 is provided below with respect to FIG. 8.

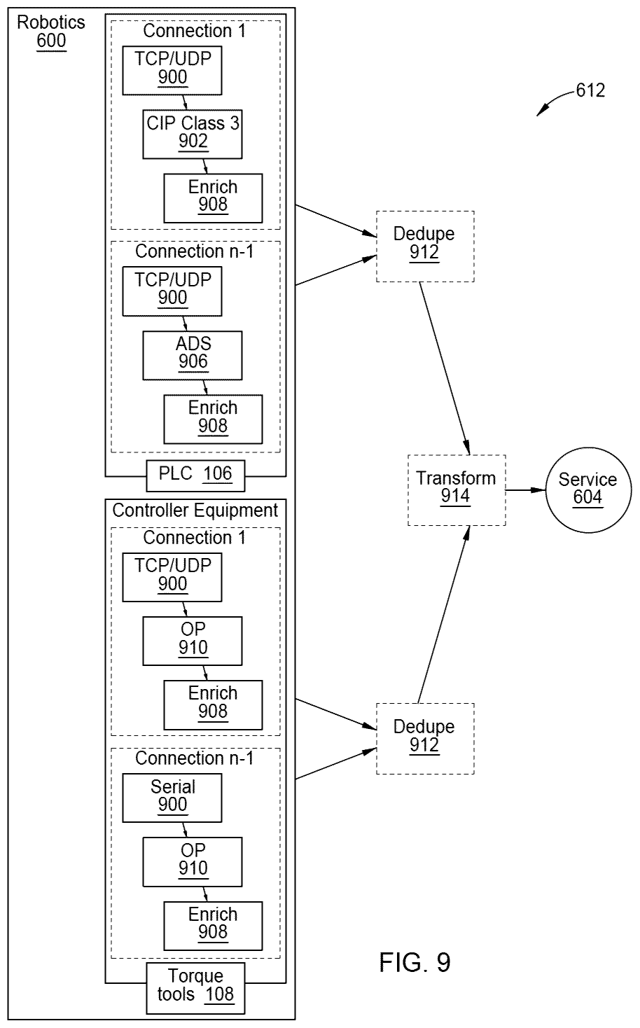

The device interface 112 may include a runtime model 612, such as a runtime model 612 for each tool 108 or multiple tools 108 constituting a station on a production line or an entire production line. The runtime model 612 may be understood as executable code used to implement communication with PLCs 106 controlling the tool 108 or a particular tool 108 used without a PLC 106. The runtime model 612 may define transformations used to transform data and routines used to de-duplicate data as described below. The runtime model 612 may be for a topology including multiple PLCs 106 and/or tools 108 and therefore defining transforms, de-duplication routines and other data that is configured specific to the topology. The runtime model 612 is described in greater detail below with respect to FIG. 9.

FIG. 7 provides a more detailed view of the operation of the transform 602. The transform 602 may provide a transformation that facilitates communication between the robotics 600 and the services 604. For example, the robotics 600 may be provided by a plurality of vendors such as ALLEN BRADELY, SIEMENS, BECKHOFF, or the like. The services 604 may be implemented as a NATS JETSTREAM, SNOWFLAKE database, KENSIS stream, S3 storage from AWS, and/or an FTPC from ROCKWELL.

The transform 602 may include a parsing stage 702. The parsing stage 702 parses a stream of bits into individual characters, e.g., symbols including multiple bits. The characters may then be processed by a sampling stage 704. The sampling stage 704 is programmed with logic for a source of the stream of bits, the logic being configured to identify control characters and other patterns in order to identify groups of characters representing words, such as instructions, error messages, status messages, or other information.

The sampling stage 704 may also perform a translation of words into a vendor agnostic format. For example, error messages having the same meaning may be translated into a common data word, values (e.g., positions in three-dimensional space, temperature, torque, etc.) may be translated into a common representation, operations (e.g., welds) may be represented in a common format, or the like. The sampling stage may additionally enrich the transformed data words. For example, a data word may be annotated with a source of the data word, e.g., an identifier of a PLC 106 and/or tool 108, a time stamp, contextual information (part number being processed, task of a process definition 314, command, etc.), or other information. In another example, a message received from a PLC 106 and/or tool 108 is enriched by annotating the message with data read from the memory of the PLC 106 and/or tool 108.

The transform 602 may include an aggregation stage 706. The aggregation stage 706 aggregates transformed data words as output by the sampling stage 704 into groups based on similarity or relatedness to provide a data structure that is used by higher-level logic such as the topology model 608. The aggregation stage 706 may include aggregating over time, e.g., aggregating transformed data words describing location together to facilitate tracking a path of an end effector of a robotic arm. Transformed data words describing any other measured value and may be aggregated over time. Transformed data words may be aggregated based on relationship: positional measurements for a robotic arm and values obtained from or describing the state of an end effector of the robotic arm.

FIG. 8 illustrates an example operation of the concurrency model 610. The concurrency model 610 enables the parallel processing of data between the robotics 600 and the services 604 and asynchronous operation of the robotics 600 with respect to the services 604. FIG. 8 illustrates the flow of data from robotics 600 to one or more services 604. The illustrated components for a particular PLC 106 may execute within a thread of execution with similar components for another PLC 106 executing within a different thread of execution.

Data from robotics 600, such as the illustrated ALLEN BRADLEY device, is received by a tap 806 of a transform stage 804. The tap 806 may be embodied as a port, interface, or other data structure or component that receives a stream of data from the robotics 600. The tap 806 may terminate a connection according to a networking protocol such as UDP, TCP, or the like. The tap 806 may implement some or all of the functions of the transform 602 and may therefore output data in the form of characters, data words, or transformed and enriched data words obtained from a stream of bits received from the robotics 600. The transform stage 804 may implement some or all of the functionality of the transform 602.

The transform stage 804 may further include a metrics stage 808. The metrics stage 808 performs monitoring of the robotics 600, including measuring the occurrence and number of alarms, reading of status variables from memory of the robotics 600. The metrics may be obtained by the metrics stage 808 by counting occurrences of messages from the robotics 600 or transmitted to the robotics during a time window or otherwise accumulating data describing data transferred to and/or from the robotics 600.

The data output by the tap 806 and/or metrics stage 808 is processed by subsequent transform stage 810. The transform stage 810 may generate events 812 based on data received from the tap 806. For example, an event 812 may be embodied as a vendor-agnostic event derived from the characters, data words, or transformed and enriched data words obtained from the tap 806. The event 812 may include characters, data words, or transformed and enriched data words grouped together based on some or all of location, device type, identifier, and/or some other variable.

The events 814 may be generated by the transform stage 810 based on outputs of the metrics stage 808. For example, events 814 may be generated according to a predefined interval, e.g. every X milliseconds, based on thresholds (a value for a metric exceeding a threshold value), receiving a particular type of message (e.g., a particular error message or class of error message), or some other criteria.

The events 812, 814 may be processed by a transform 816. The transform 816 may include various de-duplication stages 818. Each de-duplication stage 818 may execute within a different thread of execution to facilitate parallel processing. The de-duplication stages 818 include logic configured to avoid redundancy and inconsistency. The data streamed from the robotics 600 may be a continuous stream and is not synchronized with the services 604 that are monitoring or controlling the robotics 600. Likewise, the rate at which the robotics 600 output data may be much faster than the rate at which the services 604 process the data and output commands.

A de-duplication stage may include logic specific to the PLC 106 that receives the events 812 and 814 and either suppresses or aggregates some of the events 812, 814. For example, the same events 812 may communicate the same status information for the PLC 106 without any change in value such that a single event 812 of multiple events 812 is retained with the remainder being suppressed. In another example, the status information for the PLC 106 changes such that events 812 indicating the status information prior to the change are suppressed. For example, suppose a sensor provides go/no-go output. If events 812 include both go and no-go messages, a single no-go event 812 may be retained with events including go messages being suppressed.

Events 812, 814 remaining, or as transformed, by the transform 816 may be processed by a sampling stage 820. Each sampling stage 820 may execute within a different thread of execution to facilitate parallel processing. The sampling stage 820 may include data translators 822, each configured to perform a translation between the data format of the events 812, 814 and a data format of a particular service 604 that is a consumer of the events 812, 814. There may be multiple separate data translator 822 each configured to interface with one or more services 604.

The flow of data from a service 604 to the robotics 600 may be the reverse of the process used to pass data from the robotics 600 to the service 604. For example, an original message, such as a process definition 314, is sent to the sampling stage 820. A translator 822 corresponding to the source of the original message translates the message into one or more events 812, which may be in a vendor-agnostic representation such that messages from multiple different vendors in multiple different vendors are translated into the same vendor-agnostic representation by the translators 822.

The one or more events 812 are passed to the transform 816. The transform 816 may either (a) do nothing or (b) perform de-duplication. For example, if the source of the original message has sent multiple messages invoking the same one or more commands, a single instance of the original message (i.e., the one or more events 812 derived therefrom) may be selected by the transform 816 to forward to the transform stage 810. The transform stage 810 may translate the one or more events 812 into a vendor-specific series of one or more binary code words. The transform stage 810 will then transmit the one or more binary code words to the tap 806. The tap 806 translates the one or more binary code words to a stream of bits transmitted to the robotics 600 according to a networking protocol used to connect the robotics 600 to the transform stage 804.

FIG. 9 illustrates a runtime model 612 for one or more PLCs 106 and one or more tools 108 used without an intervening PLC 106. The runtime model 612 may include a state machine, emulator, or other executable that models the function of the robotics 600 and functions of the device interface 112 with respect thereto. The runtime model 612 may include executable code defining the functioning of TCP/UDP connection 900 to a PLC 106 or tool 108 and possibly one or more higher-level protocol layers such as a class 3 common industrial protocol (CIP) connection 902, automation device specification (ADS) connection 906, OP connection 910, or other type of connection. The runtime model 612 may include executable code 908 configured to enrich data received from a particular PLC 106 or tool 108, such as any of the types of enrichment described herein above.

The runtime model 612 may further include executable code 912 configured to perform the de-duplication with respect to data received from a PLC 106 or tool 108 or from multiple PLCs 106 and/or tools 108. The executable code 912 may therefore be used to implement the de-duplication stages 818 as described above.

The runtime model 612 may include executable code 914 defining transformations of data for one or more PLCs 106 and/or tools 108, such as any of the transformations described herein with respect to the transform 602 or the transform stages 804, 810 or the sampling stage 820. The executable code 914 may define the transformations in topology-sensitive manner that accounts for relationships between tools, such as tool 108 that is a robotic arm and another tool 108 that is the end effector mounted to the robotic arm.

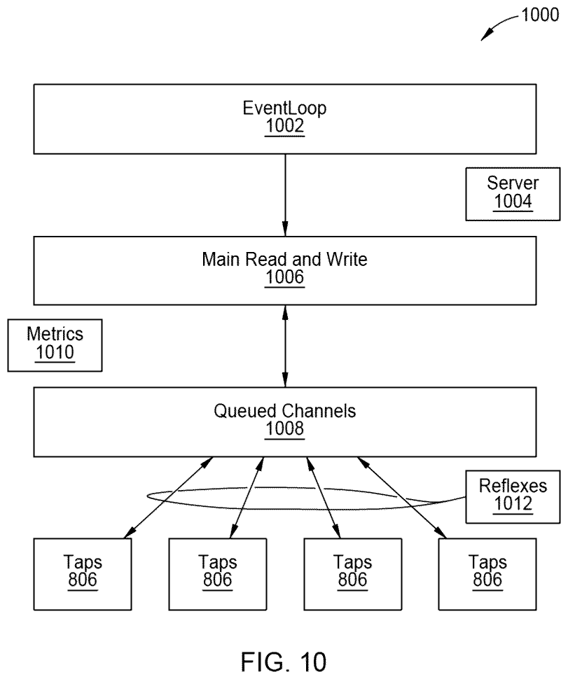

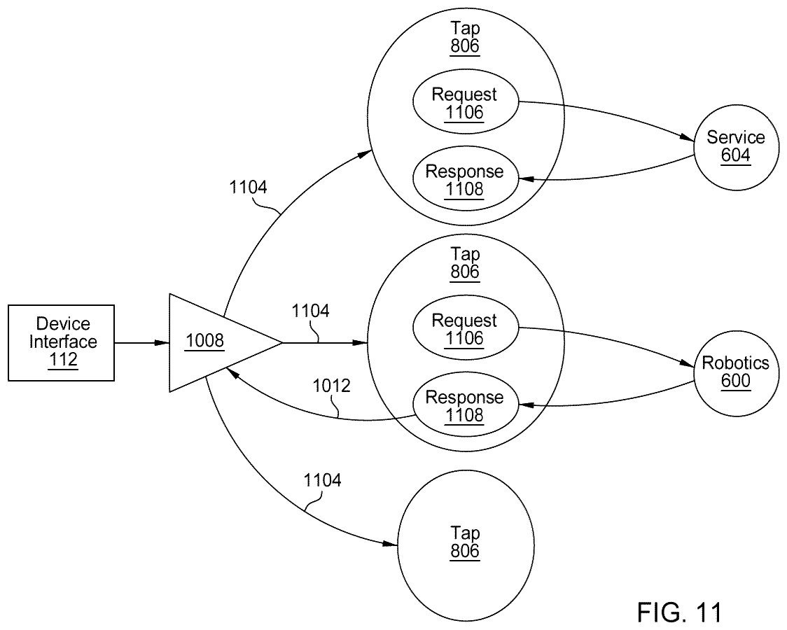

Referring to FIGS. 10 and 11, the robotics 600, i.e., any given PLC 106 and/or tool 108, may be addressable by any number of sources. These sources may include any number of services 604. Likewise, the communication manager 116 will be submitting commands to the device interface 112 for execution for any number of tasks. In addition, the communication with any given PLC 106 and/or tool 108 may be asynchronous such that the successful completion of a command may not be acknowledged before a next command is output by a source. The approach illustrated in FIGS. 10 and 11 may be used to avoid degradation of the performance of a PLC 106 or tool 108 due to excessive traffic.

Referring specifically to FIG. 10, an event processing architecture 1000 may include an event loop 1002. The event loop 1002 receives events addressed to a plurality of tools 108, directly or by way of one or more PLCs 106 by way of one or more taps 806. The events may include events 812, 814 as described above, commands issued by a communication manager 116, or other component. The event loop 1002 listens for events and forwards received events to a main read and write stage 1006. The main read and write stage 1006 writes entries to one or more queued channels 1008, each entry including an event or data derived therefrom according to some or all of the transforms described herein. For example, an entry may include a binary code that is an instruction for execution by a PLC 106 or tool 108. There may be a queued channel 1008 for each tap 806 and a tap 806 corresponding to each tool 108 addressed directly or by way of a PLC 106. Responses to events may be written to the queued channels 1008 and read from the queued channels 1008 by the main read and write stage 1006. The event loop 1002 may interface with the main read and write stage 1006 by way of a server 1004. The main read and write stage 1006 may further analyze events received and generate metrics 1010 describing the events, such as any of the metrics from metrics stage 808 described hereinabove or other types of metrics.

Each queued channel 1008 submits instructions to the corresponding tap 806 sequentially and at a rate selected to avoid overloading the PLC 106 or tool 108 to which the instructions are submitted. To that end, reflexes 1012 may provide feedback to each queued channel 1008 regarding the state of the corresponding PLC 106 or tool 108. Each queued channel 1008 will then select the rate at which instructions are submitted to the corresponding PLC 106 or tool 108 according to the feedback.

Referring to FIG. 11, the reflexes 1012 may be collected using the illustrated components. Instructions sent to the queued channels 1008 from the device interface 112 are stored as entries in the queued channels 1008 and then forwarded by the queued channels 1008 to taps 806 as messages 1104 transmitted to the taps 806. In response to each message 1104, the tap 806 that received the message 1104 generates a request 1106 that is transmitted to the robotics 600, i.e., a PLC 106 or tool 108 addressed by the message. The request 1106 may include a binary code included in the message or obtained by transforming the message and may be sent according to any of the networking protocols described herein to the robotics 600. A corresponding response 1108 may be received in response to the request 1106. The response 1108 may be some or all of (a) an acknowledgement of successful or unsuccessful completion of an instruction (b) data retrieved from the memory of the robotics 600, or some other data. The response 1108 may be forwarded to the queued channels 1008 as the reflexes 1012. The response 1108 may be used as feedback to determine the rate at which entries in the queued channels 1008 are forwarded to the robotics 600 in various ways.

In a first example, a time at which a response is received is used to determine loading of the robotics 600. In a second example, the response includes status information read from the memory of the robotics 600. For example, the status information may be a measure of latency, a measure of processor loading, a measure of memory usage, a processor temperature, or other parameters that has at least some correspondence to loading. The response 1108 according to any of these examples may therefore be processed to obtain the reflex 1012 providing feedback to the queued channel 1008 regarding the robotics corresponding to the queued channel 1008.

Note that in some embodiments, a similar approach may be used to avoid overloading of a service 604. A response 1108 from the service 604 may include or be processed to obtain a metric of loading of the service 604 according to any of the approaches described above that is used as the reflex 1012. A queued channel 1008 corresponding to the service 604 may then use the reflex 1012 to select a rate at which entries in the queued channel 1008 are forwarded as messages 1104 to the service 604.

The descriptions of the various embodiments of the present disclosure have been presented for purposes of illustration. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely illustrative.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Certain types of storage devices that include these mediums include: diskette, hard disk, random access memory (RAM), read only memory (ROM), erasable programmable read only memory (EPROM or Flash memory), static random access memory (SRAM), compact disc read only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, refers to non-transitory storage rather than transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but the storage device remains non-transitory during these processes because the data remains non-transitory while stored.

While the foregoing is directed to embodiments of the present disclosure, other and further embodiments may be devised without departing from the basic scope thereof, and the scope thereof is determined by the claims that follow.

What is claimed is:

1. A system comprising:
one or more processing devices; and
one or more memory devices operably coupled to the one or more processing devices, the one or more memory devices storing executable code that, when executed by the one or more processing devices, causes the one or more processing devices to:
connect to one or more programmable controllers that are coupled to one or more manufacturing tools, which are configured to perform a physical action contributing to manufacture of a product;
extract, via the one or more programmable controllers, tool data associated with the one or more manufacturing tools, wherein the tool data describes services performed by the one or more manufacturing tools;
upon receiving a process definition from a remote manufacturing control system, translating the process definition into commands to the one or more manufacturing tools according to the tool data; and
facilitate execution of the commands such that the one or more manufacturing tools perform one or more physical actions corresponding to the process definition.

2. The system of claim 1, wherein the tool data includes one or more command sets; and
wherein the executable code, when executed by the one or more processing devices, further causes the one or more processing devices to translate the process definition into the commands to the one or more manufacturing tools using the one or more command sets.

3. The system of claim 1, wherein the executable code, when executed by the one or more processing devices, further causes the one or more processing devices to manage sequential submission of the commands to the one or more manufacturing tools.

4. The system of claim 1, wherein the executable code, when executed by the one or more processing devices, further causes the one or more processing devices to asynchronously report results of the commands to the remote manufacturing control system.

5. The system of claim 4, wherein the executable code, when executed by the one or more processing devices, further causes the one or more processing devices to translate the results to obtain translated results and transmit the translated results to the remote manufacturing control system.

6. The system of claim 1, wherein the executable code, when executed by the one or more processing devices, further causes the one or more processing devices to request the process definition from a database.

7. The system of claim 1, wherein the executable code, when executed by the one or more processing devices, further causes the one or more processing devices to cooperate with the one or more programmable controllers to discover the tool data in response to one or more messages from the one or more programmable controllers.

8. A system comprising:
a plurality of manufacturing tools configured to perform a physical action contributing to manufacture of a product;
one or more programmable controllers coupled to the plurality of manufacturing tools; and
one or more lineside units coupled to the one or more programmable controllers, the one or more lineside units each configured to:
cooperate with the one or more programmable controllers to discover tool data describing services performed by one or more of the plurality of manufacturing tools;
receive a process definition from a remote manufacturing control system; and
translate the process definition into commands to the plurality of manufacturing tools according to the tool data.

9. The system of claim 8, wherein the tool data include includes one or more command sets, the one or more lineside units each configured to translate the process definition into the commands to the plurality of manufacturing tools using the one or more command sets.

10. The system of claim 8, wherein each of the one or more lineside units is configured to manage submission of the commands to the plurality of manufacturing tools.

11. The system of claim 10, wherein the one or more lineside units are configured to:
read status information from a memory of each programmable controller of the one or more programmable controllers; and
control a rate at which the commands are submitted to the one or more programmable controllers according to the status information.

12. The system of claim 8, wherein the one or more lineside units are configured to asynchronously report results of the commands to the remote manufacturing control system.

13. The system of claim 12, wherein the one or more lineside units are configured to translate the results to obtain translated results and transmit the translated results to the remote manufacturing control system.

14. The system of claim 8, wherein each of the one or more lineside units is configured to request the process definition from a database.

15. The system of claim 8, wherein each lineside unit of the one or more lineside units is configured to cooperate with the one or more programmable controllers to discover the tool data in response to one or more messages from the one or more programmable controllers.

16. A method for manufacturing a product comprising:
connecting a programmable controller to a lineside unit, the programmable controller coupled to one or more automated tools configured to perform a physical action contributing to manufacture of the product;
receiving, by the lineside unit, tool data from the programmable controller, the tool data including a command set for the one or more automated tools;
receiving, by the lineside unit, a process definition from a remote manufacturing control system;
translating, by the lineside unit, the process definition into a plurality of commands using the tool data; and
sequentially invoking, by the lineside unit, execution of the plurality of commands by the programmable controller and the one or more automated tools to implement the process definition.

17. The method of claim 16, further comprising asynchronously reporting, by the lineside unit, results of the plurality of commands to the remote manufacturing control system.

18. The method of claim 17, further comprising:
translating, by the lineside unit, the results to obtain translated results; and
transmitting, by the lineside unit, the translated results to the remote manufacturing control system.

19. The method of claim 16, further comprising:
detecting, by the lineside unit, modification of a remote database, the remote database being a factory talk production center (FTPC) database; and
in response to detecting modification of the remote database, retrieving, by the lineside unit, the process definition from the remote database.

20. The method of claim 16, wherein the lineside unit is within eight meters of the one or more automated tools.
